(19) United States
(12) Patent Application Publication
(10) Pub. No.: US 2009/0081626 A1
(43) Pub. Date: Mar. 26, 2009

(54) System and method for assessing cognitive function and measuring treatment efficacy

(76) Inventors: William Milgram, Toronto (CA); Joseph Araujo, Toronto (CA)

Correspondence Address: DALINA LAW GROUP, P.C., 7910 IVANHOE AVE. #325, LA JOLLA, CA, 92037, US

(21) Appl. No.: 11/453,563

(22) Filed: Jun. 14, 2006

Related U.S. Application Data
(60) Provisional application No. 60/690,698, filed on Jun. 14, 2005.

(51) Int. Cl. G09B 19/00

(52) U.S. Cl. 434/236

(57) ABSTRACT

Embodiments of the invention described herein relate generally to a method for assessing cognitive function and measuring treatment efficacy. Assessing the efficacy of clinical treatments is important for development of new interventions, for example drugs, gene, protein or antibody therapies, as well as for monitoring patient responses to approved and prescribed therapies. It is feasible to use modified versions of tests developed for experimental animals, such as primates or canines, to evaluate cognition in humans. Because the tasks are non-verbal, individuals with severely limited cognitive abilities can be objectively evaluated. Inferences can be made about the human neuropathology because the neural substrates underlying the ability to perform these tasks in animals have been delineated.

This application claims benefit of U.S. Provisional Patent Application Ser. No. 60/690,698, filed Jun. 14, 2005 entitled “SYSTEM AND METHOD FOR ASSESSING COGNITIVE FUNCTION AND MEASURING TREATMENT EFFICACY” the specification of which is hereby incorporated herein by reference.

### BACKGROUND OF THE INVENTION

1. Field of the Invention

Embodiments of the invention described herein relate generally to a system and method for assessing cognitive function and measuring treatment efficacy. More particularly, but not by way of limitation, these embodiments yield improved analysis of human cognitive function for example as it relates to the diagnosis of neurological and psychiatric diseases, monitoring the progression of disease states, or to testing the safety or efficacy of treatment of patients with drugs or other interventions. In another embodiment of the invention, these same tasks can be used in an experimental animal, for example but not by way of limitation, the canine.

2. Description of Related Art

Documentation of cognitive functioning is important for diagnosis of disease states, examining normal cognitive decline during aging, and for monitoring the efficacy or side effects of clinical treatments. The most common method of assessing cognitive mental status currently is the Mini Mental State Exam (MMSE) which is an eleven question test designed to examine orientation, attention, immediate and short-term recall, language, and the ability to follow simple verbal and written commands (Folstein et al., 1975). Typically a clinician administers this test with pencil and paper and good performance requires such skills as recalling words provided by the examiner and copying a design drawn by the examiner. Among the limitations of this test (Anthony et al., 1982) are: 1) A person who does not speak English well or who has vision, hearing, or motor difficulties may do poorly on the test but may not have significant memory problems; 2) This test provides an overall score but does not provide specificity with respect to individual clinical syndromes. 3) This test can only be administered to human subjects, therefore it cannot be used as a tool in monitoring efficacy of potential new disease therapies in experimental animals.

An alternative method for examining cognitive function is CANTAB, a series or interrelated computerized tests administered using a touch sensitive screen. Compared with the MMSE, CANTAB is difficult to use and requires specialized equipment. Like the MMSE, CANTAB is limited to use with human subjects and there are no closely parallel tasks to those in CANTAB, which can readily be applied to experimental animals.

Currently available methods for examining cognitive functioning are confounded by their dependence on intact language systems and minimal baseline levels of cognitive function. Novel clinical therapies undergo preliminary tests in experimental animals, however the cognitive abilities of animals differ from those of humans and the animal tasks used often extrapolate poorly to human behavior. Therefore, testing of therapies for cognitive impairment currently also requires large-scale clinical trials in humans, first to evaluate safety and then to evaluate efficacy. This process is time-consuming and extremely expensive, costing many millions of dollars. The scale and expense of such trials effectively limits the development of clinical therapies to only the largest and best-funded companies. Streamlining the clinical development process requires an improved ability to test cognitive function in an accurate and unbiased way in humans and requires improved animal testing methods that more closely mirror human cognitive testing. An improved method is required whereby a series of tasks unbiased by language, motor impairment, or low cognitive function can be quantitatively and reproducibly administered with testing software. Ideally, the neuroanatomical substrates underlying the tasks should be known, clarifying the importance of each task to a particular type of cognitive impairment. Further, the same tasks should also be readily applicable to an experimental animal with minor modification. In this way the tasks could be used for pre-clinical predictive screening of new therapies, expediting therapy development in a cost-effective manner. Such an improved method is described in this application.

### SUMMARY OF THE INVENTION

Embodiments of the invention described herein relate generally to a method for assessing cognitive function and measuring treatment efficacy. Assessing the efficacy of clinical treatments is important for development of new interventions, for example drugs, gene, protein or antibody therapies, as well as for monitoring patient responses to approved and prescribed therapies. It is feasible to use modified versions of tests developed for experimental animals, such as primates or canines, to evaluate cognition in humans. Because the tasks are non-verbal, individuals with severely limited cognitive abilities can be objectively evaluated. Inferences can be made about the human neuropathology because the neural substrates underlying the ability to perform these tasks in animals have been delineated. Further, therapeutic treatments shown in experimental animals to be effective at enhancing performance on these tasks are likely to also enhance performance in humans, providing a tool to expedite the development and evaluation of clinical therapies. When the protocols defined in accordance with one or more embodiments of the invention are followed, it is feasible to predict within a certain threshold what treatments have a higher efficacy upon cognition. The current application describes a method for administering a battery of cognitive tests with a software system configured to implement one or more aspects of the method described herein. Upon completion of the test battery in accordance with the procedures set for the herein the efficacy of a particular treatment is derived.

### BRIEF DESCRIPTION OF THE DRAWINGS

The invention will now be described in relation to the drawings in which:

FIG. 1 illustrates a modified version of the Wisconsin General Testing Apparatus for use with human subjects in combination with testing software configured to guide administration of the test.

FIG. 2. illustrates an example of a test apparatus used to conduct cognitive testing in canine or other companion animals in accordance with one or more embodiments of the invention.

FIG. 3 illustrates a high-level view of the process for applying the cognitive testing to a preliminary group of subjects for the purpose of screening potential therapies for effectiveness before initiating a clinical trial.

FIG. 4a illustrates a more detailed view of the process for administering a battery of cognitive tests in accordance with one or more embodiments of the invention.

FIG. 4b illustrates further detail of the process for administering a battery of cognitive tests in accordance with one or more embodiments of the invention.

FIG. 5 illustrates a protocol for implementing a delayed non-matching to sample test in accordance with one or more embodiments of the invention.

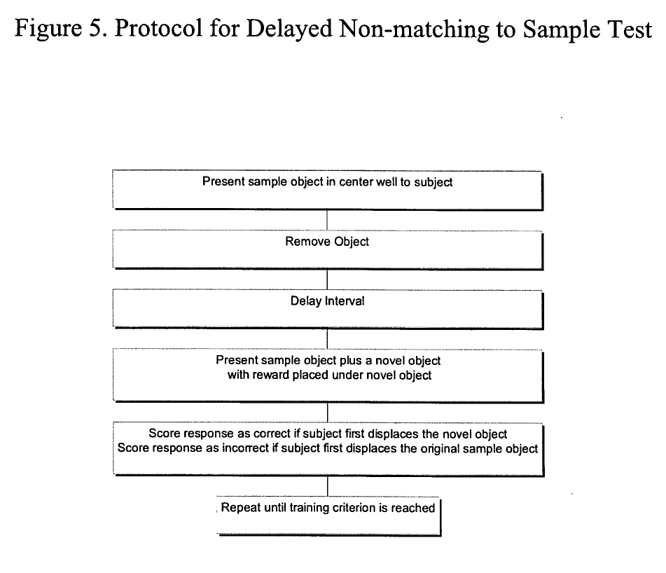

FIG. 6 illustrates a protocol for implementing a delayed non-matching to sample test in accordance with one or more embodiments of the invention.

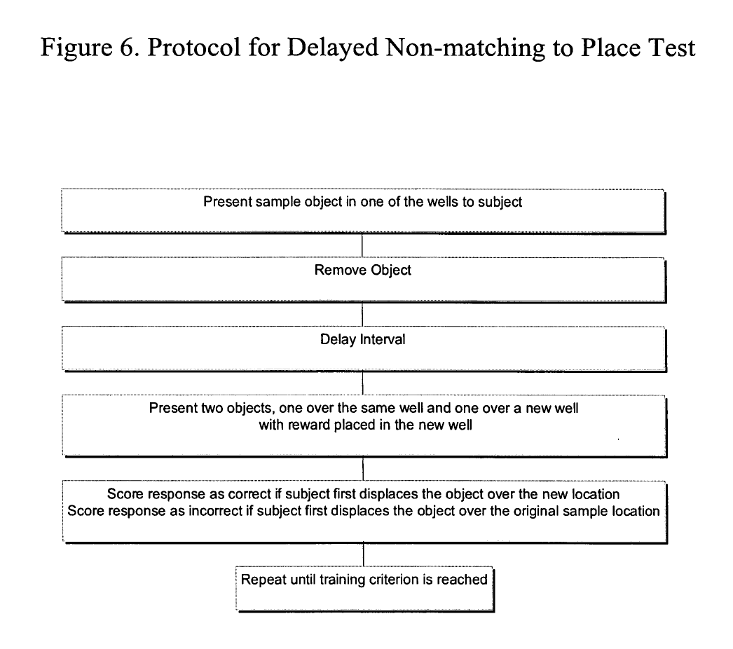

FIG. 7 illustrates a protocol for implementing an object discrimination learning test in accordance with one or more embodiments of the invention.

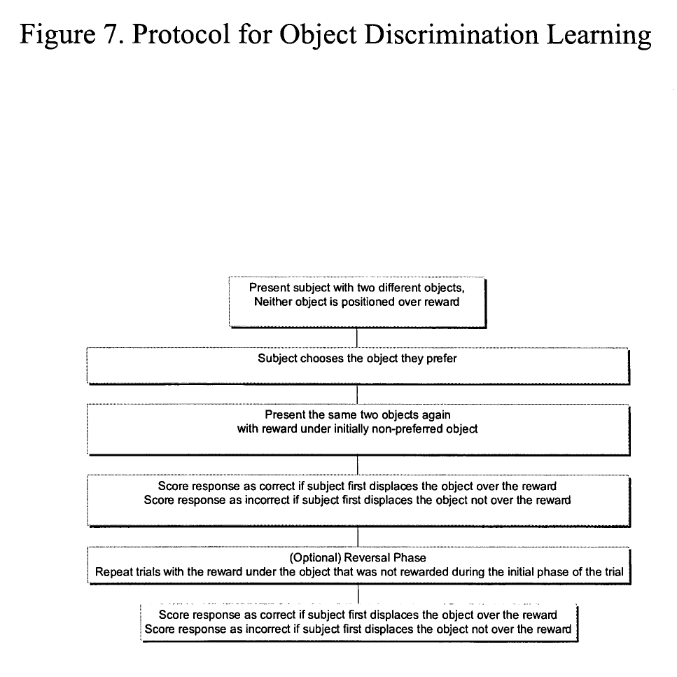

FIG. 8 illustrates a protocol for implementing an egocentric spatial discrimination task in accordance with one or more embodiments of the invention.

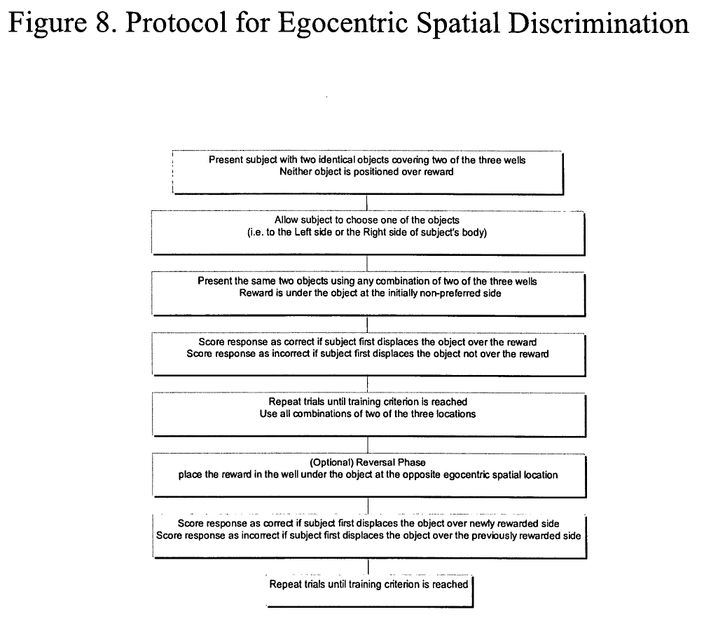

### DETAILED DESCRIPTION

Embodiments of the invention provide a reproducible and sensitive quantitative method for evaluating cognitive function of human or animal subjects on one or more tasks. In or more instances, the outcome of the evaluation in canines is used to predict treatment efficacy in humans. The method for such testing is described in detail below in which numerous specific details are set forth in order to provide a more thorough description of the present invention. It will be apparent, however, to one skilled in the art that embodiments of the present invention may be practiced without these specific details.

Embodiments of the invention described herein relate generally to a method for assessing cognitive function and measuring treatment efficacy. Assessing the efficacy of clinical treatments is important for development of new interventions, for example drugs, gene, protein or antibody therapies, as well as for monitoring patient responses to approved and prescribed therapies. It is feasible to use modified versions of tests developed for experimental animals, such as primates or canines, to evaluate cognition in humans. Because the tasks are non-verbal, individuals with severely limited cognitive abilities can be objectively evaluated. Inferences can be made about the human neuropathology because the neural substrates underlying the ability to perform these tasks in animals have been delineated. Further, therapeutic treatments shown in experimental animals to be effective at enhancing performance on these tasks are likely to also enhance performance in humans, providing a tool to expedite the development and evaluation of clinical therapies. When the protocols defined in accordance with one or more embodiments of the invention are followed, it is feasible to predict within a certain threshold what treatments have a higher efficacy upon cognition. The current application describes a method for administering a battery of cognitive tests with a software system configured to implement one or more aspects of the method described herein. Upon completion of the test battery in accordance with the procedures set for the herein the efficacy of a particular treatment is derived.

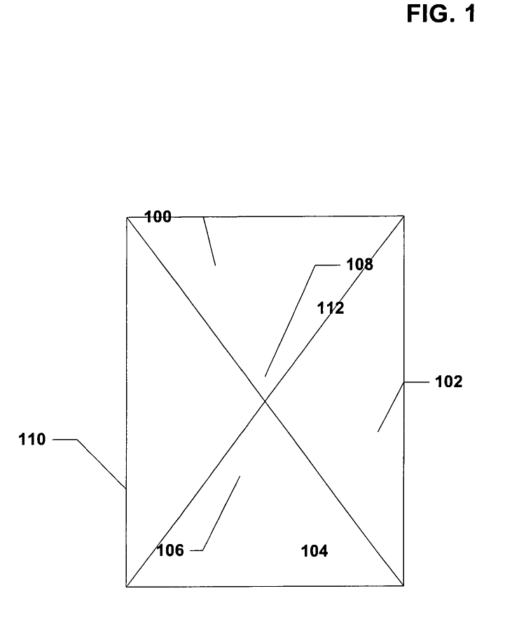

In one or more embodiments of the invention human subjects are tested using software combined with a modified version of the Wisconsin General Testing Apparatus (See e.g., FIG. 1). The apparatus comprises a vertical panel (100) and a horizontal box with a sliding tray (102). The tray contains reinforcement wells (104). In the example depicted there are three wells. The bottom of the vertical panel comprises a hinged door (106) that can be opened and closed to allow the investigator to move the tray towards and away from the participant. When the door is closed, the subject cannot see the tray or the investigator. In one embodiment of the invention, vertical panel 100 has a one-way mirror window (108) that allows the investigator to see the subject and that can be opened to allow the investigator and subject to communicate. The base (110) of the apparatus is placed on a table or other surface and the investigator and the subject sit on each side of the apparatus. In one case all objects (112) are coupled with coasters that fit tightly over the well to ensure that the well is not uncovered when the tray is moved. The objects used as stimulus cue can be a large variety of objects, but are in some instances small common household objects such as blocks of legos, coins or other types of objects. The subjects are typically instructed to try to find a reward hidden under the objects, for example a nickel. The software is used to control timing and randomization procedures, to indicate stimuli and reward locations, to store responses, latencies and comments, and to generate and store back-up electronic files at the end of a session. Use of this apparatus for human cognitive testing is described in detail in “Boutet, I., Ryan, M., Kulaga, V., McShane, C., Christie, L. A., Freedman, M., and Milgram, N. W. (2005). Age-associated cognitive deficits in humans and dogs: a comparative neuropsychological approach. Prog Neuropsychopharmacol Biol Psychiatry 29, 433-441” which is herein incorporated by reference.

The testing apparatus or other modifications of such a testing apparatus are used in conjunction with software configured to administer one or more of the following seven tasks or variations thereof. The tests described herein are examples and it is within the scope and spirit of the invention for the test administrator to vary the test protocol in instances where such variations are appropriate.

Delayed Non-matching to Sample (DNMS). For the DNMS task, participants are presented with a sample object in the center well. This object is removed and following a delay interval, participants are presented with the sample object plus a novel object, one over the right well and one over the left well. The reward is placed in the well beneath the novel object. The DNMS task is used to evaluate object recognition. Moreover, correct performance on the DNMS requires the acquisition of the abstract rule of ‘novelty,’ that is to pick an object that does not match the sample

Delayed Non-matching to Place (DNMP). The DNMP task is similar to the DNMS task in that it too involves a non-matching strategy. It differs from the DNMS in that the successful strategy for solving the task is based on a spatial location rather than an object identity. One object is presented over one of the wells. The tray is subsequently removed and after a delay interval, two objects are shown, one over the same well and one over a new well. The object presented at the new well is rewarded. The DNMP task serves as a spatial counterpart to the DNMS. It is used to evaluate spatial memory as well as the acquisition of a novelty rule.

Object Discrimination Learning. During object discrimination learning, participants are presented with two different objects, one of which is deemed positive and associated with the reward. On the first trial, no object is rewarded and participants are free to choose their preferred object. For the remaining trials, the reward is always placed under their initially non-preferred object. This task evaluates the ability to form an association between a stimulus and a reward as well as the ability to discriminate between two objects on the basis of visual attributes. During the optional reversal phase the same two objects are used but the reward contingencies are reversed and the reward is placed under the object that was not rewarded in the initial training phase. Because reversal learning requires inhibiting a previously learned association and shifting to a new strategy, it is considered a measure of executive function or cognitive flexibility.

Egocentric Spatial Discrimination. Participants are repeatedly shown two identical objects covering all combinations of two of the three wells. The rewarded spatial location is determined by reference to the participant's body position, i.e., according to an egocentric frame of reference. Participants are rewarded for selecting the object closest to the right side of their body, or the object closest to the left side of their body. For example, if the rule is to select the object closest to the right side of the body, a nickel is placed under the rightmost object on the tray (e.g., nickel under the center well and no nickel under the left well). On the first trial, no well is reinforced and participants are free to choose their preferred side. For the remaining trials, the nickel is always placed in the well corresponding to the non-preferred side. During the optional reversal phase of this testing mode, the reward contingency is reversed so that the rewarded spatial location is switched from left to right or vice versa. This mode is similar to the object discrimination except that a rule based on visuo-spatial egocentric coordinates has to be employed to solve the task.

Face Discrimination. During this phase of testing the objects that are used are photographs of faces. Participants are presented with two photographs of different faces, one of which is deemed positive and associated with the reward. On the first trial, neither face is rewarded and participants are free to choose which face they prefer. For the remaining trials, the reward is always placed under the participant's initially non-preferred face. This task evaluates the ability to form an association between a stimulus (in this case, the face) and a reward as well as the ability to discriminate between two faces on the basis of visual attributes. During the optional reversal phase the same two faces are used but the reward contingencies are reversed and the reward is placed under the face that was not rewarded in the initial training phase. Because reversal learning requires inhibiting a previously learned association and shifting to a new strategy, it is considered a measure of executive function or cognitive flexibility.

Oddity. Subjects can be trained on a series of oddity discrimination learning tasks. In each such task, the subject is presented with three objects, two identical and one different with the reward associated with the odd object. This training can be done in a series of increasingly difficult trials based on increasing similarity between the rewarded object (the odd object) and the non-rewarded objects (the two identical objects).

Contrast Discrimination. For the contrast discrimination phase subjects are initially trained to discriminate between two high contrast shapes. For example but not by way of limitation, subjects could be trained to discriminate between a black circle on a white background and a black triangle on a white background. On the first trial, neither shape is rewarded and subjects are free to choose the preferred shape. For the remaining trials, the reward is always placed under their initially non-preferred shape. In subsequent phases of the training task difficulty is increased by decreasing the contrast between the shape and the background, either by decreasing the darkness of the foreground or increasing the darkness of the background.

In one or more embodiment of the invention experimental animals are used as the subjects in the cognitive testing. For example, but not by way of limitation, canines can be tested using the modified version of the Wisconsin General Testing Apparatus (WGTA) depicted in FIG. 1 with minor modifications.

When cognitive function is measured in an dog or other subject before, during and after a treatment (e.g., the administration of a drug and/or other therapy) the test administrator is able to establish an indication of treatment efficacy. When the subject is a canine or other companion animal the results of the test provide a basis for predicting the efficacy of the evaluated treatment in other mammals such as humans. Hence the canine model acts as a predictor of treatment efficacy and thereby provides a way to achieve an initial indication as to the likely success or failure of the treatment in humans. When a treatment is evaluated in the context of a canine, but the measures taken provide a basis for determining if the treatment merits further investigation and is likely to be effective in humans, the benefit is significant. There are various regulations that must be met in order to sell or otherwise release a treatment (particularly a drug compound) to the general public. Hence clinical trials are required to prove the effectiveness and safety of the treatment before a company is permitted to sell the treatment. The cost of these clinical trials is significant and often a trial is started before there is any solid indication as to whether the drug is going to be effective in humans. Many drugs are initially developed using rats and then primates as the basis for development and testing. Even if the drug is effective in the rat and primate test subjects whether the drug ends will be effective in humans is hard to predict and clinical trials are frequently undertaken in instance where there appears to be a modicum of success in prior studies. Once clinical trials are undertaken the significant cost of setting up the study is incurred. One or more embodiments of the invention provide a series of steps that precede the clinical trial and provide an indication as to the probable success of the clinical trial. In cases where the indications of success are not apparent from this set of preceding evaluations on canines, a more informed decision can then be made about whether the clinical trial is worthwhile. In cases where the treatment is shown to be effective in canines and predicted to also be effective in humans, clinical trials can be undertaken with a higher level of confidence as to the ultimate outcome of the trial. The suitability of the dog model as a predictor of the efficacy of drugs for cognitive therapy is validated in Ikeda-Douglas, C. J., de Rivera, C., and Milgram, N. W. (2005) “Pharmaceutical and other uses of the dog model.”, Prog Neuropsychopharmacol Biol Psychiatry 29, 355-360, and Studzinski, C. M., Araujo, J. A., and Milgram, N. W. (2005) “The canine model of human cognitive aging and dementia: Pharmacological validity of the model for assessment of human cognitive-enhancing drugs”, Prog Neuropsychopharmacol Biol Psychiatry 29, 489-498 both of which are herein incorporated by reference. See also, Boutet, I., Ryan, M., Kulaga, V., McShane, C., Christie, L. A., Freedman, M., and Milgram, N. W. (2005) “Age-associated cognitive deficits in humans and dogs: a comparative neuropsychological approach” Prog Neuropsychopharmacol Biol Psychiatry 29, 433-441 which is incorporated herein by reference. See also, Christie, L. A., Studzinski, C. M., Araujo, J. A., Leung, C. S., Ikeda-Douglas, C. J., Head, E., Cotman, C. W., and Milgram, N. W. (2005). “A comparison of egocentric and allocentric age-dependent spatial learning in the beagle dog”, Prog Neuropsychopharmacol Biol Psychiatry 29, 361-369 which is incorporated herein by reference.

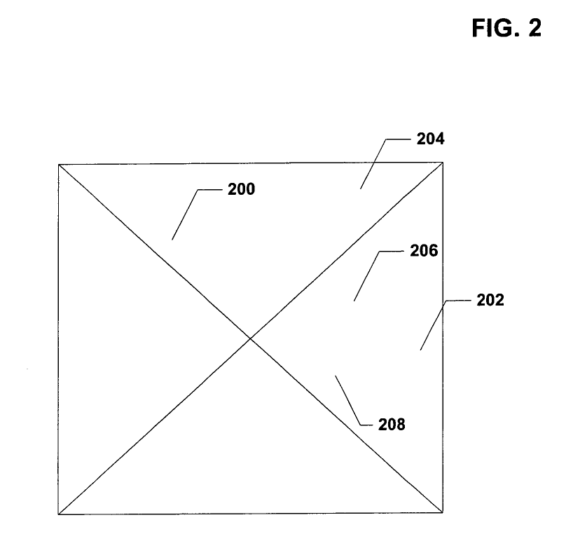

FIG. 2 shows an example of a test apparatus used to conduct cognitive testing in canine or other companion animals in accordance with one or more embodiments of the invention. The test apparatus in at least one embodiment of the invention includes a chamber (200) in which the dog resides and the reward is appropriate to the species, for example food rather than nickels as in the example described above for human subjects. The testing apparatus is equipped with a sliding food tray (202) with food wells (e.g., three wells, two lateral and one medial, although more can be used). An adjustable barrier (204) at the front of the box provides openings for the dog to obtain food from the food wells. The experimenter is separated visually from the dog by a one-way mirror (206); a hinged door (208) is located below mirror 206. Each test trial begins with hinged door 208 being opened for the presentation of tray 202. In order to control for odor cues during behavioral testing, the same food is placed under non-rewarded (negative) objects in such a way as to be inaccessible to the dog even when the object was displaced.

In one or more embodiments of the invention the experimental animals can be tested in each of the tasks described above: delayed non-matching to sample, delayed non-matching to place, object discrimination, egocentric spatial discrimination, face discrimination, oddity, and contrast discrimination. For example, when dogs are used for the delayed non-matching to sample task, testing would proceed as follows. The dogs are first given a sample trial consisting of the presentation of a single object (the sample) covering reward in the middle food well and withdrawing the tray after the animal has displaced the object and eaten the reward. Then, after a delay interval, the dogs are presented with two objects covering the left and right food wells. One of these objects is the sample, which covered an empty well; the other object is novel and is associated with the food reward.

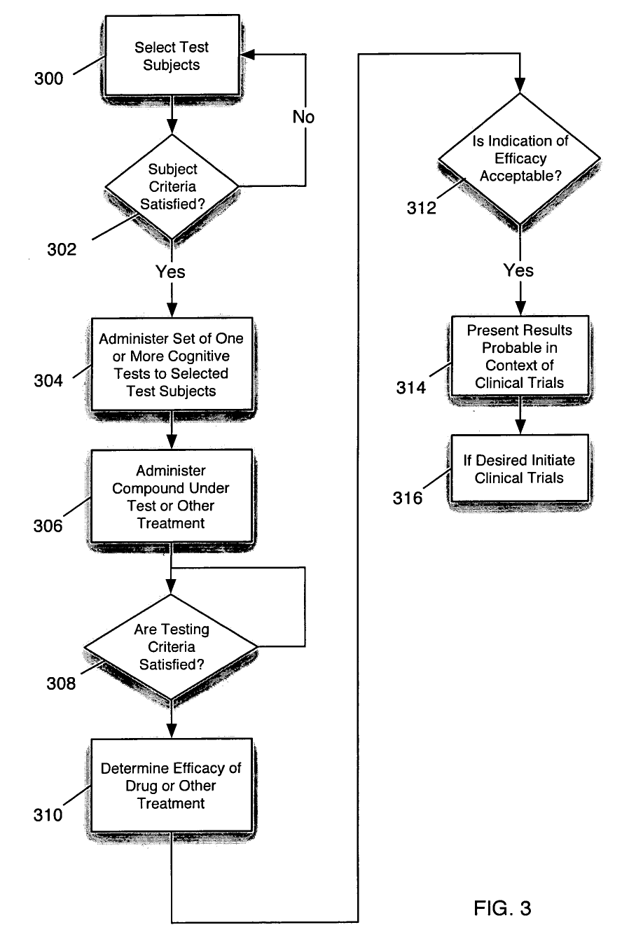

General Methodology: FIG. 3 illustrates a high-level view of the process for applying the cognitive testing to a preliminary group of subjects for the purpose of screening potential therapies for effectiveness before initiating a clinical trial. The process initiates when the experimenter selects appropriate test subjects for the treatment to be evaluated (e.g. step 300). For example, in one embodiment of the invention the experimenter could select an aged group of dogs for the purpose of pre-clinical testing of a potential therapy to treat cognitive decline in aging humans. Once the criterion for a sufficient number of appropriate subjects is satisfied (step 302) the experimenter administers a set of one or more cognitive tests using the software to the control timing and randomization procedures, the stimuli and reward locations, to store responses, latencies and comments pertaining to each subject, and to generate and store back-up electronic files at the end of a session (step 304). In this example such an initial testing session would serve to provide a baseline evaluation of performance on the tasks that could later be compared with performance following administration of the treatment to be evaluated. Following collection of this baseline data the therapy to be evaluated could be administered. For example, but not by way of limitation, this therapy could be comprised of a drug compound, an RNA, DNA, protein, peptide or antibody treatment, a surgery, a type of somatic manipulation, or a cognitive or psychiatric therapy (step 306). Subjects would then be tested again. In one embodiment, testing could be repeated at the conclusion of the treatment regime. In another embodiment, testing could be conducted repeatedly during the course of treatment. The experimenter may then evaluate whether sufficient testing data has been collected (step 308). If the data is insufficient, additional data may be collected. If the data is sufficient and the previously established testing criterion are satisfied, the data from the pretreatment baseline cognitive testing can be compared with the post-treatment data to determine the efficacy of the potential therapy (step 310). If the indication of efficacy provided in this manner is acceptable (step 312), the results can be presented as pre-clinical predictive screening evidence that would support the initiation of clinical trials (step 314). If the evidence does not support efficacy of the therapy then one or more variables of the therapeutic regime (step 306) could be altered, for example, treatment dosage, length of treatment, frequency of treatment, and the process could be reinitiated with a new set or the same set of subjects (step 100). After sufficient iterations of the process are completed to produce a favorable demonstration of efficacy of the therapy being evaluated the treatment could be applied to a human clinical trial (step 316). For example, in the case given above if a treatment was shown to decrease the cognitive impairments in a set a aging canines, the same treatment could be evaluated in a clinical trial of normal aged humans or a clinical of humans with cognitive impairment. Alternatively, if the treatment were found to be ineffective it could be abandoned saving the expense and effort of proceeding with the development of a clinical trial.

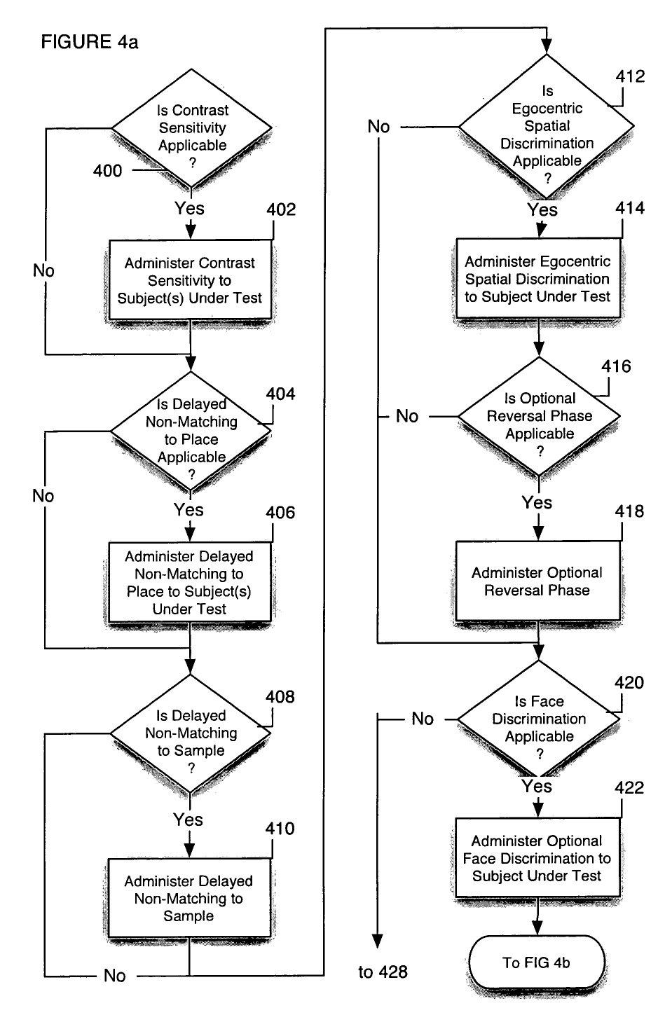

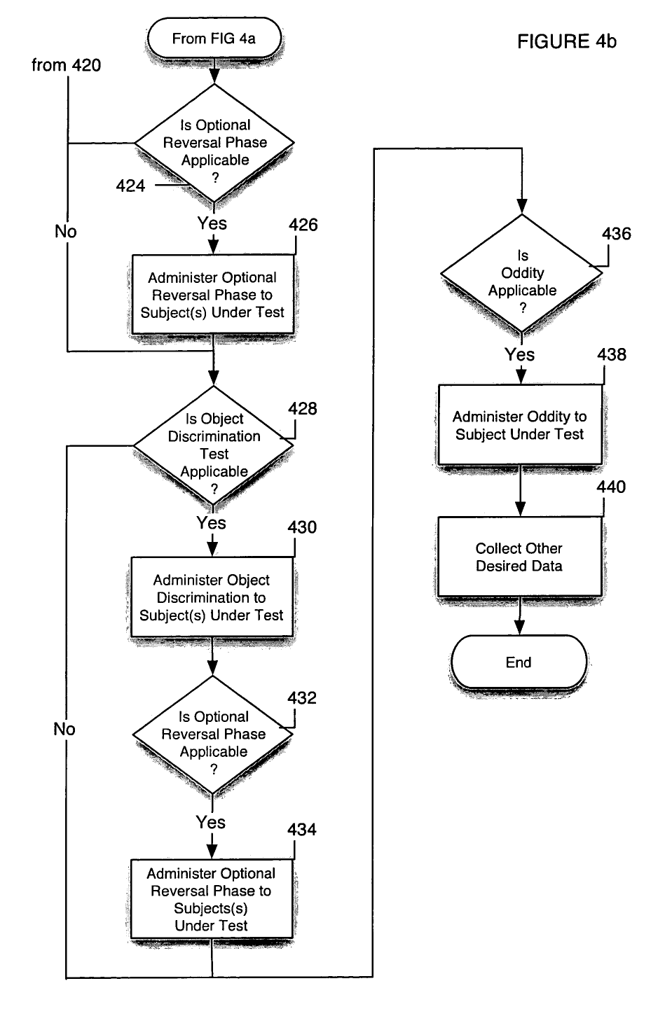

FIGS. 4a and 4b presents a more detailed view of the process for administering a battery of cognitive tests in accordance with one or more embodiments of the invention. The process is guided by decisions of the experimenters regarding whether each of the tasks is appropriate for the specific study being conducted. If the task is appropriate it is administered. If the task is not appropriate, another task of the battery is considered and so forth. Hence all tasks need not be administered. The order of tasks presented in the figure is an example, not by way of limitation, of the order in which the tasks could be administered. Any alternative order of task administration is possible. In the following description “the experimenter” can refer to the individual(s) designing the study before it is conducted, the individual(s) responsible for physically administering the cognitive testing, and the individual(s) analyzing and interpreting the data after it is collected. In the example in FIG. 4a the process is initiated when the experimenter considers if administering the contrast sensitivity task is appropriate for the study at hand (step 400). If the contrast sensitivity task is appropriate it is administered and data collection proceeds using the software to the control timing and randomization procedures, the stimuli and reward locations, to store responses, latencies and comments pertaining to each subject, and to generate and store back-up electronic files at the end of a session (step 402). If the contrast sensitivity task is not appropriate the experimenter considers if the delayed non-matching to place task is applicable to the objectives of the study (step 404). If the delayed non-matching to place task is appropriate the experimenter administers the delayed non-matching to place task to the subjects (step 406). If the delayed non-matching to place task is not appropriate then the experimenter considers whether the delayed non-matching to sample task is appropriate (step 408).

If the delayed non-matching to sample task is appropriate the experimenter administers the delayed non-matching to sample task to the subjects (step 410). If the delayed non-matching to sample task is not appropriate then the experimenter considers whether the egocentric spatial discrimination task is appropriate (step 412).

If the egocentric spatial discrimination task is not appropriate then the experimenter considers whether the face discrimination task is appropriate (step 420). If the egocentric spatial discrimination task is appropriate the experimenter administers the egocentric spatial discrimination task to the subjects (step 414). The experimenter next considers whether it is desirable to collect data from the optional reversal phase of the egocentric discrimination task (step 416). If so, the reversal phase of egocentric discrimination is administered (step 418). If the reversal phase data is not desired then the experimenter proceeds to consideration of face discrimination (step 420). If the face discrimination task is not appropriate then the experimenter considers whether the object discrimination task is appropriate (step 428). If the face discrimination task is appropriate the experimenter administers it to the subjects (step 422). The experimenter next considers whether it is desirable to collect data from the optional reversal phase of the face discrimination task (step 424). If so, the reversal phase of face discrimination is administered (step 426). If the reversal phase data is not desired then the experimenter proceeds to consideration of the object discrimination (step 428). If the object discrimination task is not appropriate then the experimenter considers whether the oddity task is appropriate (step 436). If the object discrimination task is appropriate the experimenter administers the object discrimination task to the subjects (step 430). The experimenter then considers whether the optional reversal phase of the face discrimination task is appropriate (step 432). If the reversal data is desired, the reversal phase of face discrimination is administered (step 434). If the reversal phase data is not desired then the experimenter proceeds to consideration of oddity task (step 438). If the oddity task is appropriate the experimenter administers the oddity task to the subjects (step 438). At this stage the experimenter considers if any other data should be collected. For example, but not by way of limitation, the experimenter may decide to repeat one or more of the testing steps. If so, additional data is collected (step 440) and the testing concludes when all the desired data has been collected.

Hence a system and method for assessing cognitive function and measuring treatment efficacy has been described. The claims however and the full scope of their equivalents are what define the metes and bounds of the invention.

What is claimed is:

1. A method of evaluating cognitive functioning comprising:
a) obtaining at least one subject; and,
b) administering at least one cognitive function test wherein said cognitive function test involves displacing an object to obtain a reward.

2. The method of claim 1 wherein said cognitive function test further comprises a delayed non-matching to sample task comprising:
a) Presenting said at least one subject with said object;
b) Removing said object;
c) after a delay interval, presenting said object again along with a novel second object, with said reward placed under said novel object; and
d) controlling the timing and randomization procedures, to indicate stimuli and reward locations, to store responses, latencies, and to generate and store back-up electronic files resulting from said delayed non-matching to sample task.

3. The method of claim 1 wherein said cognitive function test further comprises a delayed non-matching to place task comprising:
a) presenting said at least one subject with said object at an original presentation location;
b) removing said object;
c) after a delay interval, presenting two copies of said object one at said original presentation location and one at a novel presentation location with said reward being placed under a novel object at said novel presentation location; and
d) controlling the timing and randomization procedures, to indicate stimuli and reward locations, to store responses, latencies, and to generate and store back-up electronic files resulting from said delayed non-matching to place task.

4. The method of claim 1 wherein said cognitive function test further comprises an egocentric spatial discrimination task comprising:
a) presenting said at least one subject with two identical objects and allowing said at least one subject to select said object that is to the rightmost or leftmost of said at least one subject;
b) removing said objects;
c) presenting said two identical objects again in a variety of positions with said reward being present under said object at the initially non-preferred side.
d) controlling timing and randomization procedures, to indicate stimuli and reward locations, to store responses, latencies and comments, and to generate and store back-up electronic files resulting from said egocentric spatial discrimination test.

5. The method of claim 1 wherein said cognitive function test further comprises an object discrimination task comprising:
a) presenting said at least one subject with two different sample objects and allowing said at least one subject to select which of said two different sample objects the subject prefers;
b) removing said two different sample objects;
c) presenting said two different sample objects again with said reward under an initially non-preferred object from said two different sample objects;
d) utilizing a computer software to control timing and randomization procedures, to indicate stimuli and reward locations, to store responses, latencies and comments, and to generate and store back-up electronic files resulting from said object discrimination task.

6. A system for testing cognitive function comprising:
a) an apparatus consisting of a vertical panel and a horizontal box with sliding, rolling, or otherwise movable tray
b) a door within said vertical panel that can be opened and closed
c) a unidirectional means to observe the other side of said vertical panel
d) a number of reinforcement wells within said movable tray
e) removable coverings for said reinforcement wells within said sample tray
f) a means for presenting stimulus objects covering or otherwise associated with said reinforcement wells.

7. A system for measuring efficacy of a compound comprising:
a) a software code;
b) a functional capacity for data collection;
c) a functional capacity for data analysis and export;
d) a functional capacity for organizing randomization, stimulus object selection, and object and reward location for one or more cognitive tasks;
e) a functional capacity to organize data acquisition by individual subject or groups of subject;
f) a functional capacity to segregate data and access privileges according to user profiles; and
g) a functional capacity to create and store backup files.

8. The method of claim 1 wherein the purpose of said testing is to evaluate the efficacy of a therapy comprising:
a) conducting initial baseline cognitive testing of subjects;
b) administering an experimental therapy;
c) conducting additional cognitive testing;
d) evaluating test results before and after the therapy to discover indicators of therapy effectiveness.

9. The method of claim 1 wherein both animal and human subjects are tested to evaluate pre-clinical efficacy of a treatment comprising:
a) identifying a potential therapy to be evaluated;
b) obtaining at least one or more animal subject(s);
c) administering and analyzing one or more tests of cognitive function;
d) administering an experimental therapy;
e) conducting additional cognitive testing;
f) utilizing the test results to provide prediction of the effectiveness of said therapy in human subjects;
g) obtaining at least one or more human subject(s);
h) administering and analyzing one or more tests of cognitive function in the human subjects;
i) administering an experimental therapy to the human subjects;
j) conducting additional cognitive testing; and
k) evaluating the test results before and after the therapy to determine therapy effectiveness.
